(19) United States
(12) Patent Application Publication
(10) Pub. No.: US 2008/0192031 A1
(43) Pub. Date: Aug. 14, 2008

(54) Apparatus and Method for Driving Display Panel

(76) Inventors: Bo-Young An, Suwon-si (KR); Joo-Hyung Lee, Gwacheon-si (KR); Seung-Bin Moon, Seoul (KR); Man-Seung Cho, Seoul (KR)

Correspondence Address: Frank Chau, Esq.;F. CHAU & ASSOCIATES, LLC, 130 Woodbury Road, Woodbury, NY, 11797, US

(21) Appl. No.: 11/870,953

(22) Filed: Oct. 11, 2007

(30) Foreign Application Priority Data
Feb. 13, 2007 (KR) 2007-14644

(51) Int. Cl. G09G 5/00

(52) U.S. Cl. 345/204

(57) ABSTRACT

An apparatus for driving a display panel includes a timing control part, a line memory part, a frame memory part and an image compensation part. The timing control part receives a horizontal synchronizing signal from an external system via a CPU interface process. The line memory part stores an image signal of an n-th frame in a line unit, based on the horizontal synchronizing signal. The frame memory part stores an image signal of an (n-1)-th frame based on the horizontal synchronizing signal. The image compensation part generates a compensated image signal of the n-th frame using the image signals of the n-th and (n-1)-th frames, which are respectively outputted from the line memory part and the frame memory part, based on the horizontal synchronizing signal. Accordingly, display quality in a CPU interface mode may be enhanced.

### CROSS-REFERENCE TO RELATED APPLICATIONS

This application claims priority under 35 U.S.C. §119 to Korean Patent Application No. 2007-14644, filed on Feb. 13, 2007 in the Korean Intellectual Property Office (KIPO), the contents of which are herein incorporated by reference in their entirety.

### BACKGROUND OF THE INVENTION

1. Field of the Invention

The present disclosure is directed to an apparatus for driving a display panel. More particularly, the present disclosure is directed to an apparatus and a method for driving a display panel having a central processing unit (CPU) interface mode.

2. Description of the Related Art

Compact liquid crystal display (LCD) apparatuses have become widely used in various fields, so that various conditions and functions of the LCD apparatuses have also become necessary. For example, a compact LCD apparatus, such as a digital camera, a digital multimedia broadcasting (DMB) device, etc., requires high display resolution and high display quality.

However, since the compact LCD apparatus is primarily manufactured to display a still image, the response speed of liquid crystal is slow and the response speed of a gray scale is much slower. An overdriving technology is applied to maintain the response speed through the entire gray scale range to easily display the video image. In the overdriving technology, the present inputted frame image signal is compensated by comparing the present inputted frame image with an image signal in a frame unit. For example, an image signal of an (n-1)-th frame is compared with an image signal of an n-th frame next to the (n-1)-th frame, to output a compensated image signal of the (n-1)-th frame. Thus, the inputted image signal is synchronized with the outputted compensated image signal in the overdriving technology.

The current compact LCD apparatus stores the image signal that is synchronized with an externally provided clock signal received from an external system in a frame memory inside of the LCD apparatus via a central processing unit (CPU) interface process, and outputs the image signal that is synchronized with an internal clock signal generated inside of the LCD apparatus and is stored in the frame memory to a display panel.

Thus, the image signal is not transmitted from the external system in real time, so that the image signal received from the external system is not synchronized with the image signal applied to the display panel. Accordingly, the overdriving technology is not easily used in the compact LCD apparatus using the CPU interface process.

### SUMMARY OF THE INVENTION

Embodiments of the present invention provide an apparatus for driving a display panel enhancing display quality of a moving image in a central processing unit (CPU) interface mode.

Embodiments of the present invention also provide a method for driving the display panel.

In an example apparatus for driving a display panel according to an embodiment of the present invention, the apparatus includes a timing control part, a line memory part, a frame memory part and an image compensation part. The timing control part receives an external horizontal synchronizing signal from an external system via a CPU interface process. The line memory part stores an image signal of an n-th frame transmitted from the external system in a line unit, based on the external horizontal synchronizing signal. The frame memory part stores an image signal of an (n-1)-th frame based on the external horizontal synchronizing signal. The image compensation part generates a compensated image signal of the n-th frame using the image signals of the n-th and (n-1)-th frames, which are respectively outputted from the line memory part and the frame memory part based on the external horizontal synchronizing signal. The number n is a natural number.

In another example apparatus for driving a display panel according to an embodiment of the present invention, the apparatus includes a clock generating part, a timing control part, a line memory part, a frame memory part and an image compensation part. The clock generating part generates an internal horizontal synchronizing signal and an internal vertical synchronizing signal. The timing control part transmits the internal horizontal synchronizing signal and the internal vertical synchronizing signal to an external system via a central processing unit (CPU) interface process. The line memory part stores an image signal of an n-th frame in a line unit, and the image signal of the n-th frame is synchronized with the internal horizontal synchronizing signal and is received from the external system. The frame memory part stores an image signal of an (n-1)-th frame based on the internal horizontal synchronizing signal. The image compensation part generates a compensated image signal of the n-th frame using the image signals of the n-th and (n-1)-th frames, which are respectively outputted from the line memory part and the frame memory part based on the internal horizontal synchronizing signal. The number n is a natural number.

In an example method for driving a display panel according to an embodiment of the present invention, an external horizontal synchronizing signal and an image signal of an n-th frame are received from an external system via a CPU interface process. The image signal of the n-th frame is stored in a line unit, based on the external horizontal synchronizing signal. The stored image signals of the (n-1)-th and the n-th frames are outputted based on the external horizontal synchronizing signal. A compensated image signal of the n-th frame is generated using the image signals of the n-th and (n-1)-th frames. The compensated image signal of the n-th frame is converted into an analog-type compensated image signal. The analog-type compensated image signal is outputted. The number n is a natural number.

In another example method for driving a display panel according to an embodiment of the present invention, an internal horizontal synchronizing signal and an internal vertical synchronizing signal are generated. The internal horizontal synchronizing signal and the internal vertical synchronizing signal are transmitted to an external system via a CPU interface process. An image signal of an n-th frame is stored in a line unit, and the image signal of the n-th frame is synchronized with the internal horizontal synchronizing signal and is received from the external system. The stored image signals of the (n-1)-th and n-th frames are outputted based on the internal horizontal synchronizing signal. A compensated image signal of the n-th frame is generated using the image signals of the n-th and (n-1)-th frames. The compensated image signal of the n-th frame is converted into an analog-type compensated image signal. The analog-type compensated image signal is outputted. The number n is a natural number.

According to an embodiment of the present invention, a compact display apparatus using a CPU interface process includes a line memory part storing an image signal in a line unit, so that the image signals of the (n-1)-th and n-th frames are synchronized with each other to generate a compensated image signal of the n-th frame.

### BRIEF DESCRIPTION OF THE DRAWINGS

The above and other features of the present invention will become more apparent by describing in detail example embodiments thereof with reference to the accompanying drawings.

FIG. 1 is a plan view illustrating a display apparatus according to an example embodiment of the present invention.

FIG. 2 is a block diagram illustrating an apparatus for driving a display panel according to an example embodiment of the display apparatus in FIG. 1.

FIG. 3 is a block diagram illustrating an apparatus for driving a display panel according to another example embodiment of the display apparatus in FIG. 1.

FIG. 4 is a flow chart showing a method for driving the apparatuses in FIGS. 2 and 3.

FIG. 5 is a block diagram illustrating an apparatus for driving a display panel according to another example embodiment of the display apparatus in FIG. 1.

FIG. 6 is a block diagram illustrating an apparatus for driving a display panel according to another example embodiment of the display apparatus in FIG. 1.

FIG. 7 is a flow chart showing a method for driving the apparatuses in FIGS. 5 and 6.

FIG. 8 is a block diagram illustrating an apparatus for driving a display panel according to another example embodiment of the display apparatus in FIG. 1.

FIG. 9 is a flow chart showing a method for driving the apparatus in FIG. 8.

FIG. 10 is a block diagram illustrating an apparatus for driving a display panel according to another example embodiment of the display apparatus in FIG. 1.

FIG. 11 is a flow chart showing a method for driving the apparatus in FIG. 10.

### DESCRIPTION OF EXEMPLARY EMBODIMENTS

Embodiments of the invention is described more fully hereinafter with reference to the accompanying drawings, in which exemplary embodiments of the invention are shown. This invention may, however, be embodied in many different forms and should not be construed as limited to the embodiments set forth herein. It will be understood that when an element or layer is referred to as being “on,” “connected to” or “coupled to” another element or layer, it can be directly on, connected or coupled to the other element or layer or intervening elements or layers may be present. Like numbers refer to like elements throughout.

Hereinafter, exemplary embodiments of the present invention will be explained in detail with reference to the accompanying drawings.

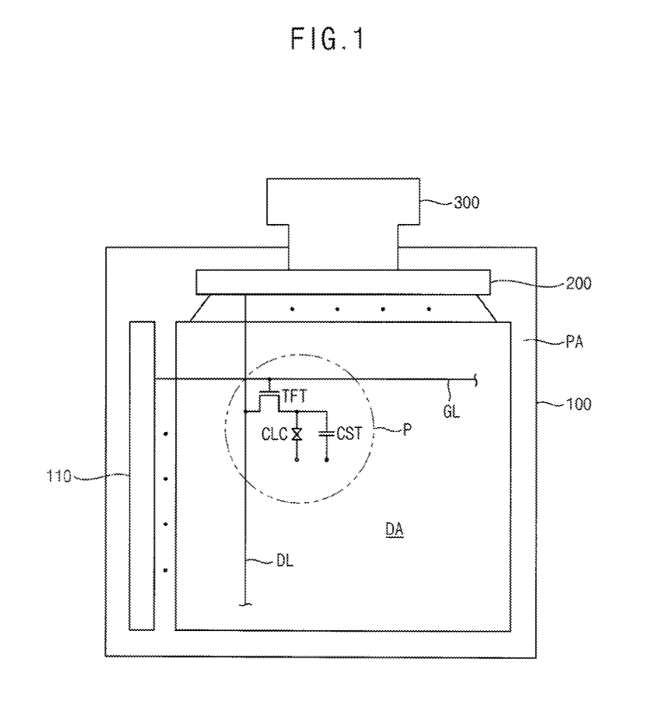

FIG. 1 is a plan view illustrating a display apparatus according to an example embodiment of the present invention.

Referring to FIG. 1, the display apparatus includes a display panel 100, an apparatus 200 for driving a display panel and a flexible printed circuit board (FPC) 300.

The FPC electrically connects an external system (not shown) with the apparatus 200 for driving the display panel 100. The external system is connected to the apparatus 200 via a central processing unit (CPU) interface process, to receive and transmit an image signal and a control signal.

The display panel 100 includes a display area DA having a plurality of pixel portions and a peripheral area PA enclosing the display area DA. Each of the pixel portions P includes a switching element TFT electrically connected to a gate line GL and a source line DL, a liquid capacitor CLC electrically connected to the switching element TFT and a storage capacitor CST electrically connected to the liquid capacitor CLC.

The apparatus 200 and a gate driving part 110 are disposed in the peripheral area PA. The apparatus 200 is mounted on the peripheral area PA corresponding to an end portion of the source line DL in a chip shape. The gate driving part 110 is integrated in the peripheral area PA corresponding to an end portion of the gate line GL, or is mounted on the peripheral area PA in the chip shape.

The apparatus 200 generates a compensated image signal of an n-th frame using an image signal of the n-th frame transmitted via the CPU interface process and a stored image signal of an (n-1)-th frame, and outputs the compensated image signal of the n-th frame to the source line. The number n is a natural number.

The gate driving part 110 outputs a gate signal to each of the gate lines, based on a gate control signal provided from the apparatus 200.

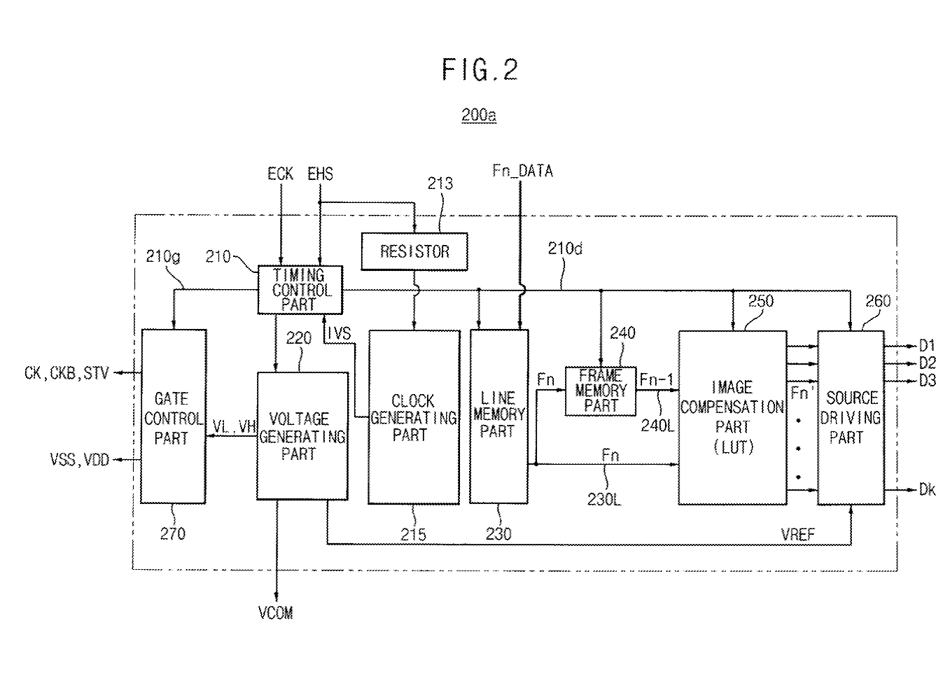

FIG. 2 is a block diagram illustrating an apparatus 200a for driving a display panel according to an example embodiment of the display apparatus in FIG. 1.

Referring to FIGS. 1 and 2, the apparatus 200a according to the present example embodiment includes a timing control part 210, a resistor 213, a clock generating part 215, a voltage generating part 220, a line memory part 230, a frame memory part 240, an image compensation part 250, a source driving part 260 and a gate control part 270.

The timing control part 210 outputs a control signal controlling the apparatus 200a, based on an external clock signal ECK and an external horizontal synchronizing signal EHS transmitted from the external system via the CPU interface process. The control signal includes a source control signal 210d controlling the line memory part 230, the frame memory part 240, the image compensation part 250 and the source driving part 260, and a gate control signal 210g controlling the gate control part 270.

The resistor 213 records a start point of a frame image signal using the external horizontal synchronizing signal EHS. The clock generating part 215 generates an internal vertical synchronizing signal IVS based on the start point of the frame image recorded in the resistor 213, and transmits the internal vertical synchronizing signal IVS to the timing control part 210. Thus, the timing control part 210 generates the source control signal 210d and the gate control signal 210g, based on the external clock signal ECK, the external horizontal synchronizing signal EHS and the internal vertical synchronizing signal IVS.

The voltage generating part 220 generates driving voltages depending on a control of the timing control part 210. The driving voltages includes a gate voltage VL and VH applied to the gate control part 270, a reference gamma voltage VREF applied to the source driving part 260 and a common voltage VCOM applied to the display panel 100.

The line memory part 230 stores the image signal Fn_DATA of the n-th frame Fn, which is transmitted from the external system, in a line unit, based on the source control signal 210d synchronized with the external horizontal synchronizing signal EHS, and outputs the image signal of the n-th frame Fn to the image compensation part 250 in the line unit and the frame memory part 240. The line memory part 230 may be a line latch or a line memory, and may store at least more than two lines of the image signal.

The frame memory part 240 outputs the stored image signal of the (n-1)-th frame Fn-1 to the image compensation part 250 in the line unit, based on the source control signal 210d synchronized with the external horizontal synchronizing signal EHS, and stores the image signal of the n-th frame Fn outputted from the line memory part 230.

For example, when a k-th line image signal of the n-th frame Fn is stored in the line memory part 230, the line memory part 230 outputs the k-th line image signal of the n-th frame to the image compensation part 250 and stores the k-th line image signal of the n-th frame in the frame memory part 240. The frame memory part 240 outputs the k-th line image signal of the (n-1)-th frame Fn-1 to the image compensation part 250.

The k-th line image signal 230L of the n-th frame Fn and the k-th line image signal 240L of the (n-1)-th frame Fn-1 are inputted to image compensation part 250. The image compensation part 250 includes a look-up table (LUT) in which a compensated image signal or an operation parameter is mapped corresponding to the image signal of the (n-1)-th frame and the image signal of the n-th frame. The image compensation part 250 generates the k-th line compensated image signal Fn′ of the n-th frame using the LUT, and outputs the compensated image signal Fn′ to the source driving part 260.

The source driving part 260 converts the compensated image signal in the line unit into an analog-type compensated image signal D1, D2, . . . , Dk, and outputs the analog-type compensated image signal to the source lines of the display panel 100. The number k is a natural number.

The gate control part 270 shifts levels of the gate control signal 210g provided from the timing control part 210 and the gate voltage VL and VH provided from the voltage generating part 220, to apply the gate control signal 210g and the gate voltage VL and VH to the gate driving part 110. For example, a vertical start signal STV, a first clock signal CK, a second clock signal CKB, a gate on voltage VDD and a gate off voltage VSS are applied to the gate driving part 110.

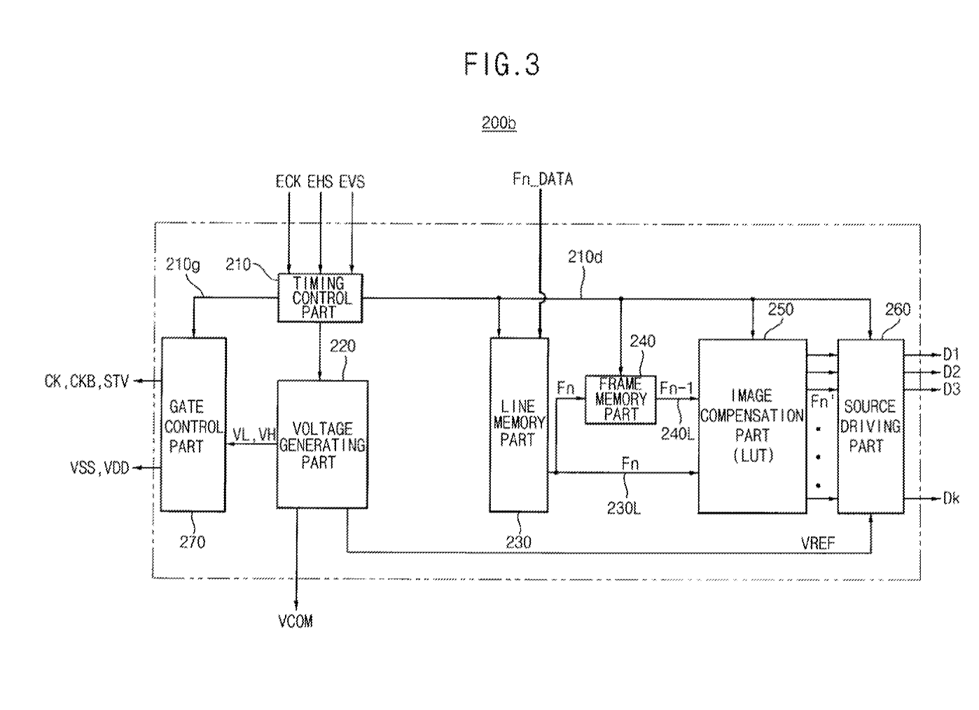

FIG. 3 is a block diagram illustrating an apparatus 200b for driving a display panel according to another example embodiment of the display apparatus in FIG. 1.

Referring to FIGS. 1 and 3, the apparatus 200b according to the present example embodiment includes a timing control part 210, a voltage generating part 220, a line memory part 230, a frame memory part 240, an image compensation part 250, a source driving part 260 and a gate control part 270.

The timing control part 210 generates a control signal synchronized with an external clock signal ECK, an external vertical synchronizing signal EHS and an external vertical synchronizing signal EVS transmitted from an external system via the CPU interface process, to control the apparatus 200b.

For example, the apparatus 200b further receives the external vertical synchronizing signal EVS from the external system. Thus, the apparatus 200b does not need to generate an internal vertical synchronizing signal IVS using a resistor 213, as in the apparatus 200a according to the previous example embodiment.

The voltage generating part 220, the line memory part 230, the frame memory part 240, the image compensation part 250, the source driving part 260 and the gate control part 270 according to the present example embodiment operate in substantially the same manner as in the first example embodiment. Thus, any further repetitive explanation concerning the above elements will be omitted.

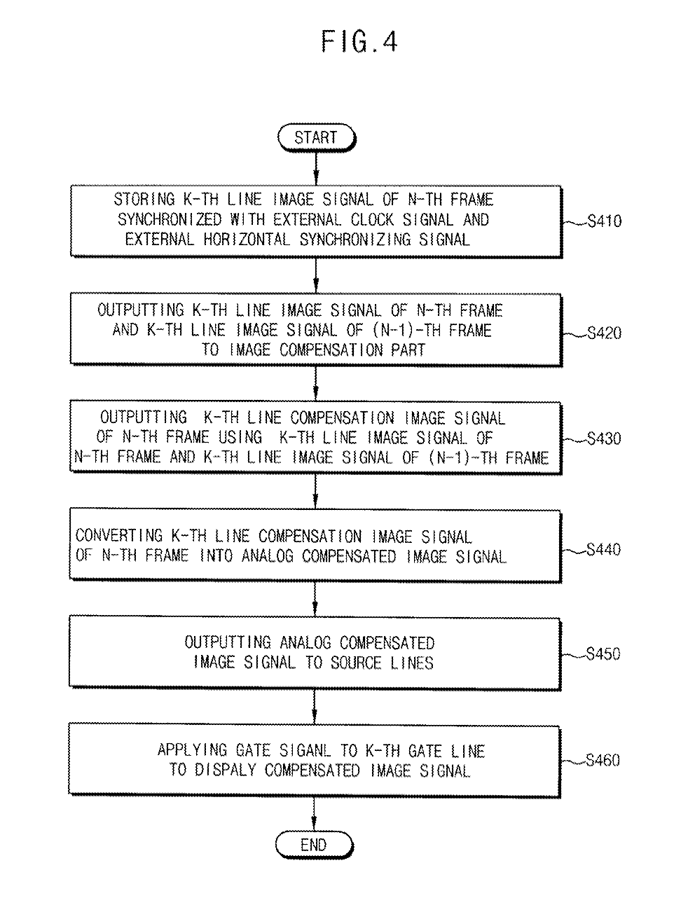

FIG. 4 is a flow chart showing a method for driving the apparatuses 200a and 200b in FIGS. 2 and 3. The method according to the present example embodiment will be described referring to the apparatus 200a in FIG. 2.

Referring to FIGS. 1, 2 and 4, in the apparatus 200a, a k-th line image signal of an n-th frame Fn, which is synchronized with an external clock signal ECK and an external vertical synchronizing signal EHS and is received from an external system, are stored in a line memory part 230 (step S410).

When the k-th line image signal of the n-th frame Fn is stored in the line memory part 230, a k-th line image signal 230L of the n-th frame Fn is outputted to an image compensation part 250 (step S420).

A frame memory part 240 outputs the stored k-th line image signal 240L of the (n-1)-th frame Fn-1, which is synchronized with an external vertical synchronizing signal EHS, to the image compensation part 250 (step S420).

The image compensation part 250 outputs a k-th line compensated image signal Fn′ of the n-th frame using the k-th line image signal 230L of the n-th frame Fn and a k-th line image signal 240L of an (n-1)-th frame Fn-1 (step S430).

A source driving part 260 converts the k-th line compensated image signal Fn′ of the n-th frame into an analog-type compensated image signal D1, D2, . . . , Dk, using a reference gamma voltage VREF (step S440).

The source driving part 260 outputs the analog-type k-th line compensated image signal D1, D2, . . . , Dk of the n-th frame to the source lines (step S450).

A gate driving part 110 outputs a gate signal to gate lines of a display panel 100, based on a control of a timing control part 210. When the k-th line compensated image signal Fn′ is outputted to the source lines, the gate signal is applied to the gate line GLk corresponding to the k-th line. Thus, a compensated image is displayed on the display panel 100 based on the compensated image signal (step S460).

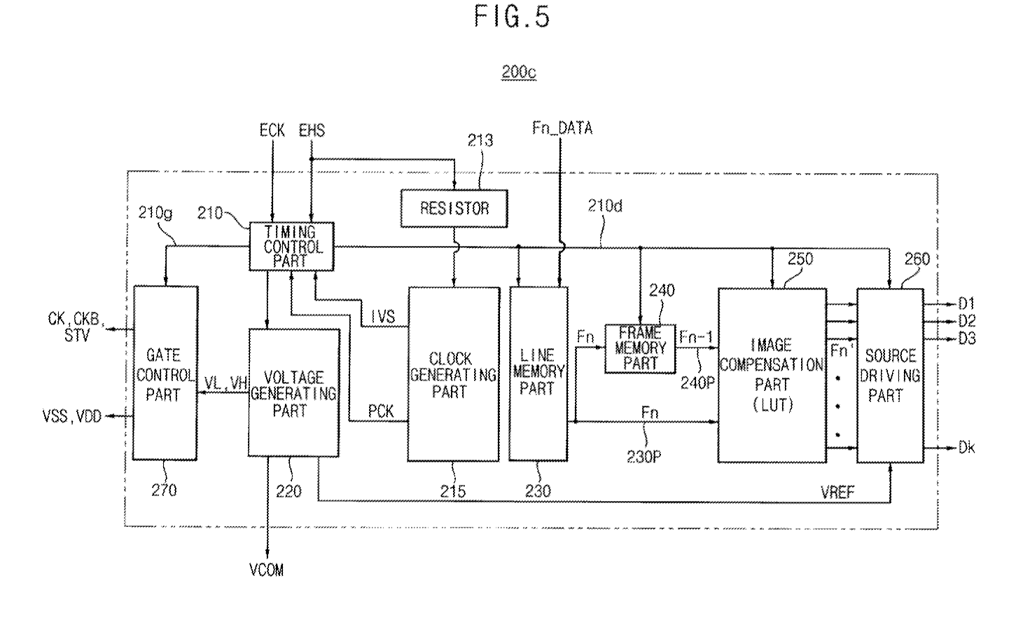

FIG. 5 is a block diagram illustrating an apparatus 200c for driving a display panel according to another example embodiment of the display apparatus in FIG. 1.

Referring to FIGS. 1 and 5, the apparatus 200c according to the present example embodiment includes a timing control part 210, a resistor 213, a clock generating part 215, a voltage generating part 220, a line memory part 230, a frame memory part 240, an image compensation part 250, a source driving part 260 and a gate control part 270.

The timing control part 210 generates a control signal synchronized with an external clock signal ECK and an external vertical synchronizing signal EHS transmitted from an external system via the CPU interface process, to control the apparatus 200c. The control signal includes a source control signal 210d controlling the line memory part 230, the frame memory part 240, the image compensation part 250 and the source driving part 260, and a gate control signal 210g controlling a gate control part 270.

A resistor 213 records a start point of the frame image signal using the external vertical synchronizing signal EHS.

The clock generating part 215 generates an internal vertical synchronizing signal IVS using the start point of the frame image signal recorded in the resistor 213. The clock generating part 215 divides the external vertical synchronizing signal EHS to generate a pixel clock signal PCK.

The clock generating part 215 applies the internal vertical synchronizing signal IVS and the pixel clock signal PCK to the timing control part 210. Accordingly, the timing control part 210 generates a source control signal 210d and a gate control signal 210g based on the external clock signal ECK, the external horizontal synchronizing signal EHS, the internal vertical synchronizing signal IVS and the pixel clock signal PCK.

The voltage generating part 220 generates driving voltages based on a control of the timing control part 210. The driving voltages includes gate voltages VL and VH applied to the gate control part 270, a reference gamma voltage VREF applied to the source driving part 260, a common voltage VCOM applied to the display panel 100.

The line memory part 230 stores the Fn image signal Fn_DATA of the n-th frame in the line unit transmitted from the external system based on the source control signal 210d synchronized with the external horizontal synchronizing signal EHS and the pixel clock signal PCK, and outputs the image signal of the n-th frame Fn to the image compensation part 250 in a pixel unit and the frame memory part 240.

The frame memory part 240 outputs the stored image signal of the (n-1)-th frame Fn-1 based on the source control signal 210d synchronized with the external horizontal synchronizing signal EHS and the pixel clock signal PCK to the image compensation part 250 in the pixel unit. In addition, the frame memory part 240 stores the image signal of the n-th frame Fn outputted from the line memory part 230.

For example, after the k-th line image signal of the n-th frame Fn is stored in the line memory part 230, the line memory part 230 outputs an k-th line pixel image signal 230P of the n-th frame to the image compensation part 250. The frame memory part 240 outputs a k-th line pixel image signal 240P of the (n-1)-th frame Fn-1 to the image compensation part 250.

The pixel image signal 230P of the n-th frame Fn and the pixel image signal 240P of the (n-1)-th frame Fn-1 are inputted to the image compensation part 250. The image compensation part 250 outputs a pixel compensated image signal Fn′ of the n-th frame, which corresponds to the pixel image signal 230P of the n-th frame, and the pixel image signal 240P of the (n-1)-th frame to the source driving part 260.

The source driving part 260 groups the compensated image signal in the pixel unit into the compensated image signal in the line unit, and converts the compensated image signal in the line unit into the analog-type compensated image signal D1, D2, . . . , Dk, to output the analog-type compensated image signal to the source lines of the display panel 100.

The gate control part 270 shifts levels of a gate control signal 210g provided from the timing control part 210 and the gate voltage VL and VH provided from the voltage generating part 220, to apply the gate control signal 210g and the gate voltage VL and VH to the gate driving part 110. For example, a vertical start signal STV, a first clock signal CK, a second clock signal CKB, a gate on voltage VDD and a gate off voltage VSS are applied to the gate driving part 110.

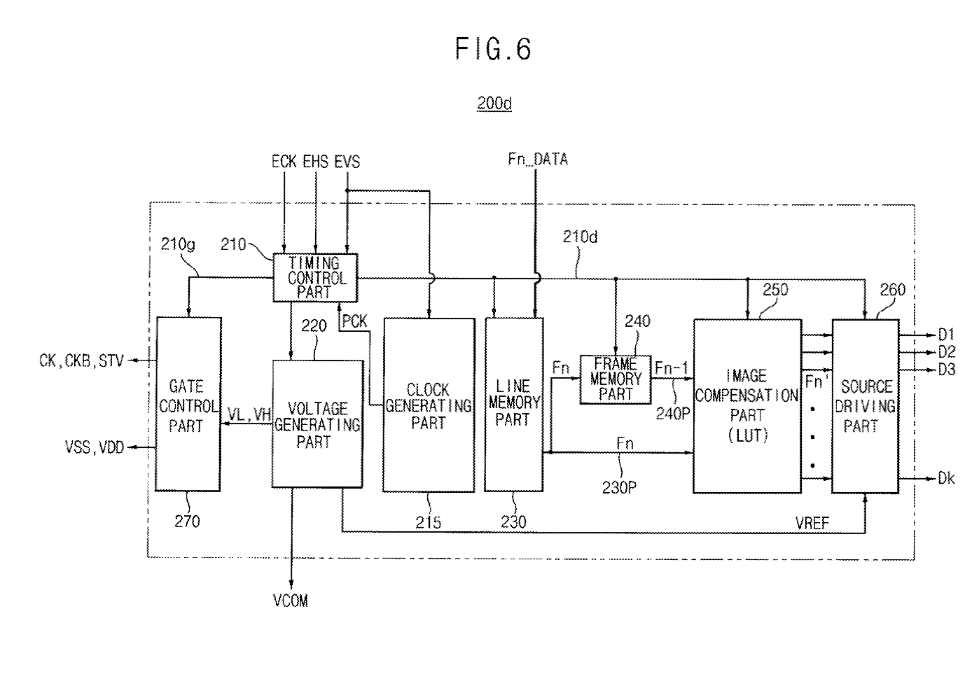

FIG. 6 is a block diagram illustrating an apparatus 200d for driving a display panel according to another example embodiment of the display apparatus in FIG. 1.

Referring to FIGS. 1 and 6, the apparatus 200d according to the present example embodiment includes a timing control part 210, a clock generating part 215, a voltage generating part 220, a line memory part 230, a frame memory part 240, an image compensation part 250, a source driving part 260 and a gate control part 270.

The timing control part 210 generates an external clock signal ECK received from an external system, and a control signal synchronized with an external horizontal synchronizing signal EHS and an external vertical synchronizing signal EVS, to control the apparatus 200d.

For example, the apparatus 200d further receives the external vertical synchronizing signal EVS from the external system in comparison with the apparatus 200b according to a previous example embodiment. Thus, the apparatus 200d does not need to generate the internal vertical synchronizing signal IVS using the resistor 213, as in the apparatus 200c according to another previous example embodiment.

The clock generating part 215 generating a pixel clock signal PCK, the voltage generating part 220, the line memory part 230, the frame memory part 240, the image compensation part 250, the source driving part 260 and the gate control part 270 according to the present example embodiment operate in substantially the same manner as in the example embodiment of FIG. 2. Thus, any further repetitive explanation concerning the above elements will be omitted.

The image signal is compensated in the line unit in the example embodiments of FIGS. 2 and 3, but the image signal is compensated in the pixel unit in the example embodiments of FIGS. 5 and 6. Thus, an amount of data processed in the image compensation part is decreased, so that a size of a logic circuit of the image compensation part is decreased.

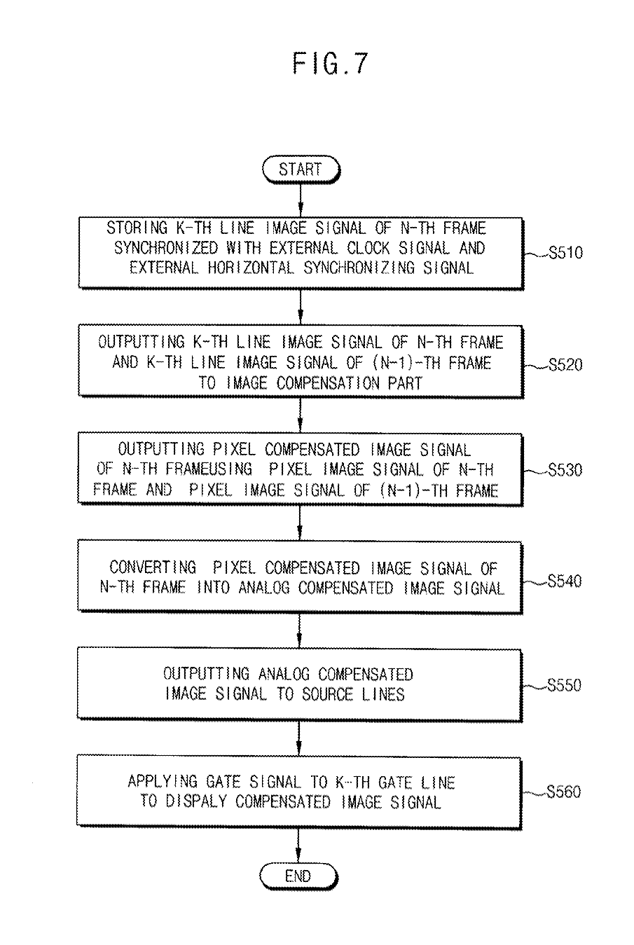

FIG. 7 is a flow chart showing a method for driving the apparatuses 200c and 200d in FIGS. 5 and 6. The method according to the present example embodiment will be described referring to the apparatus 200c in FIG. 5.

Referring to FIGS. 1, 5 and 7, an external clock signal ECK received from an external system and a k-th line image signal of an n-th frame Fn synchronized with an external horizontal synchronizing signal EHS, are stored in a line memory part 230 of the apparatus 200c (step S510).

When the k-th line image signal of the n-th frame Fn is stored in the line memory part 230, the k-th line image signal of the n-th frame Fn, which is synchronized with a pixel clock signal PCK generated by dividing an external horizontal synchronizing signal EHS, is outputted in the pixel unit. For example, the line memory part 230 outputs a pixel image signal 230P of the n-th frame Fn to an image compensation part 250 (step S520).

A frame memory part 240 outputs the stored k-th line image signal of an (n-1)-th frame Fn-1, which is synchronized with the pixel clock signal PCK in the pixel unit. For example, the frame memory part 240 outputs the pixel image signal 240P of the (n-1)-th frame Fn-1 to the image compensation part 250 (step S520).

The image compensation part 250 outputs the pixel compensated image signal Fn′ of the n-th frame using the pixel image signal 230P of the n-th frame Fn and the Fn-1 pixel image signal 240P of the (n-1)-th frame (step S530).

The source driving part 260 groups the pixel compensated image signal Fn′ of the n-th frame in a line unit, and converts a compensated image signal Fn′ of the n-th frame into an analog-type compensated image signal D1, D2, . . . , Dk using a reference gamma voltage VREF (step S540).

A source driving part 260 outputs the analog-type k-th line compensated image signal D1, D2, . . . , Dk of the n-th frame to the source lines (step S550).

A gate driving part 110 outputs a gate signal to gate lines of a display panel 100 based on a control of the timing control part 210. When the k-th line compensated image signal Fn′ is outputted to source lines, the gate signal is applied to the gate line GLk corresponding to the k-th line. Thus, a compensated image is displayed on the display panel 100 based on the compensated image signal (step S560).

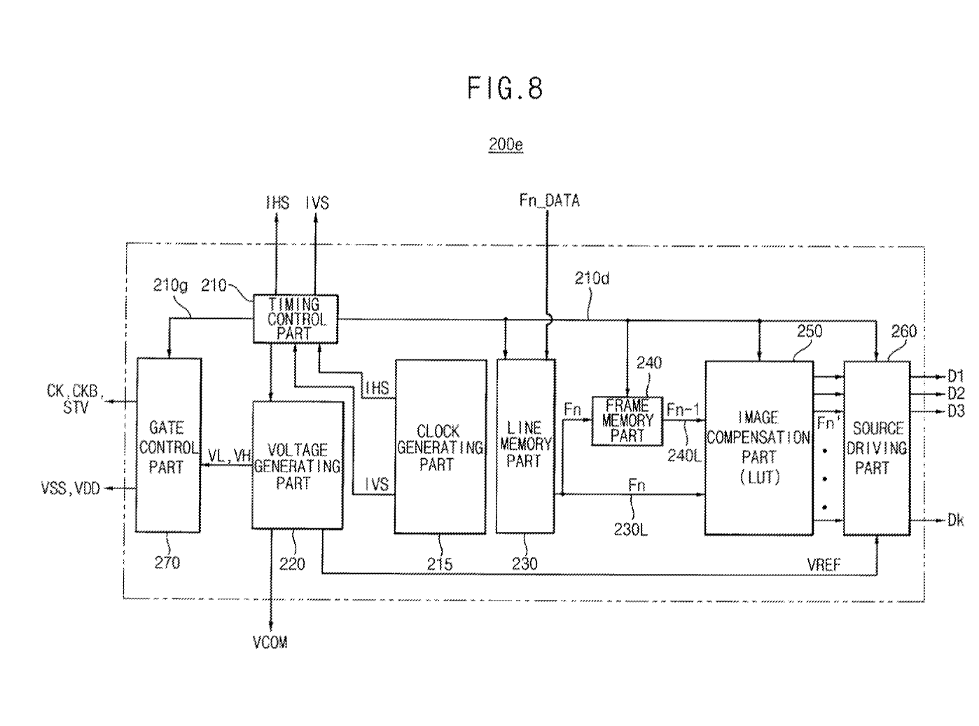

FIG. 8 is a block diagram illustrating an apparatus 200e for driving a display panel according to another example embodiment of the display apparatus in FIG. 1.

Referring to FIGS. 1 and 8, the apparatus 200e according to the present example embodiment includes a timing control part 210, a clock generating part 215, a voltage generating part 220, a line memory part 230, a frame memory part 240, an image compensation part 250, a source driving part 260 and a gate control part 270.

The timing control part 210 transmits an internal horizontal synchronizing signal IHS and an internal vertical synchronizing signal IVS generated from the clock generating part 215 to an external system. The external system transmits an image signal Fn_DATA synchronized with the internal horizontal synchronizing signal IHS and the internal vertical synchronizing signal IVS to the apparatus 200e.

The timing control part 210 generates a control signal synchronized with the internal horizontal synchronizing signal IHS and the internal vertical synchronizing signal IVS, to control the apparatus 200e. The control signal includes a source control signal 210d controlling the line memory part 230, the frame memory part 240, the image compensation part 250 and the source driving part 260, and a gate control signal 210g controlling the gate control part 270.

The voltage generating part 220 generates driving voltages based on the control of the timing control part 210. The driving voltages includes gate voltages VL and VH applied to the gate control part 270, a reference gamma voltage VREF applied to the source driving part 260 and a common voltage VCOM applied to the display panel 100.

The line memory part 230 stores the image signal of the n-th frame Fn, which is synchronized with the internal horizontal synchronizing signal IHS and the internal vertical synchronizing signal IVS and is received from the external system, in a line unit. The line memory part 230 outputs the Fn image signal of the n-th frame to the image compensation part 250 in the line unit and the frame memory part 240.

The frame memory part 240 outputs the stored image signal of an (n-1)-th frame Fn-1 to the image compensation part 250 in the line unit, based on a source control signal 210d synchronized with the internal horizontal synchronizing signal IHS and the internal vertical synchronizing signal IVS. In addition, the image signal of the n-th frame Fn outputted from the line memory part 230 is stored in the frame memory part 240.

For example, after the k-th line image signal of the n-th frame Fn is stored in the line memory part 230, the line memory part 230 outputs the k-th line image signal of the n-th frame to the image compensation part 250, and the k-th line image signal of the n-th frame is stored in the frame memory part 240. The frame memory part 240 outputs the k-th line image signal of the (n-1)-th frame Fn-1 to the image compensation part 250.

The k-th line image signal 230L of the n-th frame Fn and the k-th line image signal 240L of the (n-1)-th frame Fn-1 are inputted to the image compensation part 250. The image compensation part 250 includes an LUT in which the compensated image signal or the operating parameter is mapped corresponding to the image signal of the (n-1)-th frame and the image signal of the n-th frame. The image compensation part 250 outputs the k-th line compensated image signal Fn′ of the n-th frame to the source driving part 260 using the LUT.

The source driving part 260 converts the compensated image signal in the line unit into an analog-type compensated image signal D1, D2, . . . , Dk, to output the analog-type compensated image signal to the source lines of a display panel 100. The number k is a natural number.

The gate control part 270 shifts a level of a gate control signal 210g provided from the timing control part 210 and the gate voltage VL and VH provided from the voltage generating part 220, to apply the gate control signal 210g and the gate voltage VL and VH to the gate driving part 110. For example, a vertical start signal STV, a first clock signal CK, a second clock signal CKB, a gate on signal VDD and a gate off signal VSS are applied to the gate driving part 110.

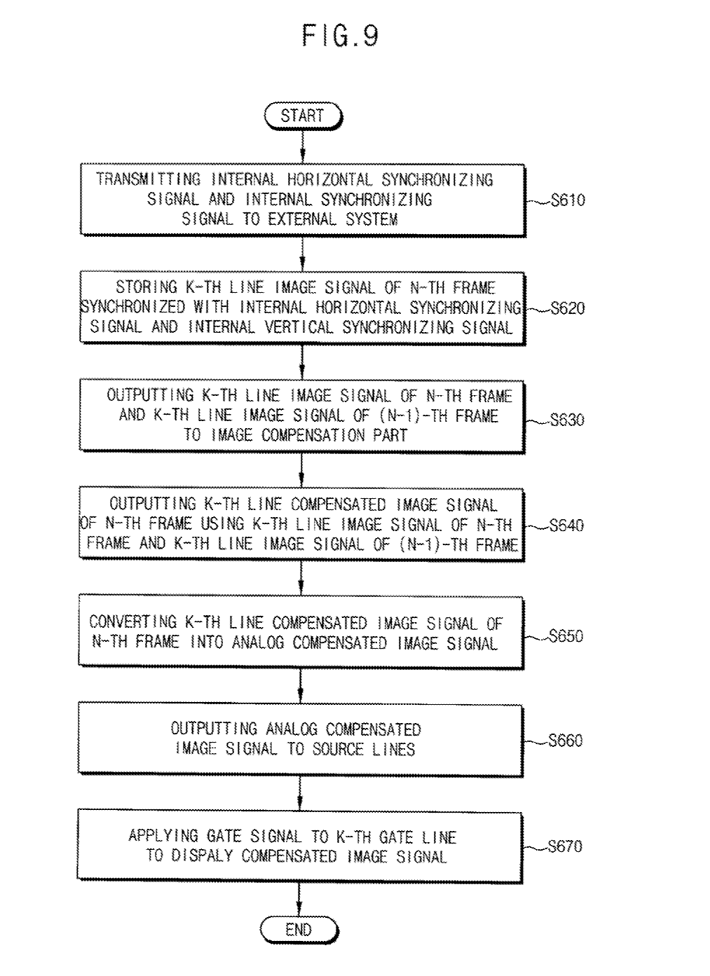

FIG. 9 is a flow chart showing a method according to an embodiment of the invention for driving the apparatus 200e in FIG. 8.

Referring to FIGS. 1, 8 and 9, the apparatus 200e transmits an internal horizontal synchronizing signal IHS and an internal vertical synchronizing signal IVS to an external system (step S610).

In the apparatus 200e, a line memory part 230 stores a k-th line image signal of an n-th frame Fn, which is synchronized with the internal horizontal synchronizing signal IHS and the internal vertical synchronizing signal IVS and is received from an external system via the CPU interface process (step S620).

When the k-th line image signal of the n-th frame Fn is stored in the line memory part 230, the k-th line image signal 230L of the n-th frame Fn, which is synchronized with the internal horizontal synchronizing signal IHS, is outputted to the image compensation part 250 (step S630).

A frame memory part 240 outputs the stored k-th line image signal 240L of the (n-1)-th frame Fn-1, which is synchronized with the internal horizontal synchronizing signal IHS, to an image compensation part 250 (step S630).

The image compensation part 250 outputs the k-th line compensated image signal Fn′ of the n-th frame using a k-th line image signal 230L of the n-th frame Fn and the k-th line image signal 240L of the (n-1)-th frame Fn-1 (step S640).

A source driving part 260 converts the k-th line compensated image signal Fn′ of the n-th frame into an analog-type compensated image signal D1, D2, . . . , Dk using a reference gamma voltage VREF (step S650).

The source driving part 260 outputs the analog-type n-th frame k-th line compensated image signal D1, D2, . . . , Dk to the source lines (step S660).

A gate driving part 110 applies a gate signal to the gate line corresponding to the k-th line, when the k-th line compensated image signal Fn′ is outputted to source lines. Thus, a compensated image is displayed on a display panel 100 based on the compensated image signal (step S670).

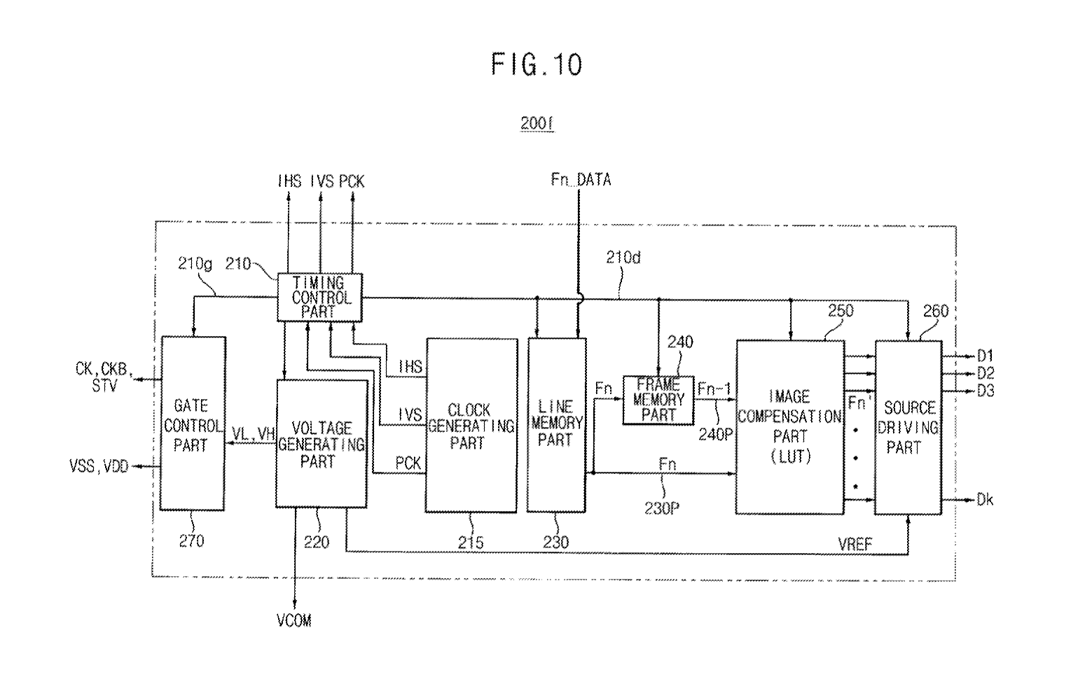

FIG. 10 is a block diagram illustrating an apparatus 200f for driving a display panel according to another example embodiment of the display apparatus in FIG. 1.

Referring to FIGS. 1 and 10, the apparatus 200f according to the present example embodiment includes a timing control part 210, a clock generating part 215, a voltage generating part 220, a line memory part 230, a frame memory part 240, an image compensation part 250, a source driving part 260 and a gate control part 270.

The timing control part 210 transmits an internal horizontal synchronizing signal IHS, an internal vertical synchronizing signal IVS and a pixel clock signal PCK generated from the clock generating part 215, to an external system.

The external system transmits an image signal Fn_DATA synchronized with the internal horizontal synchronizing signal IHS, the internal vertical synchronizing signal IVS and the pixel clock signal PCK to the apparatus 200e. For example, in the present example embodiment, the pixel clock signal PCK is further transmitted to the external system, so that the image signal transmitted from the external system is synchronized in the pixel unit.

The timing control part 210 generates the control signal synchronized with the internal horizontal synchronizing signal IHS, the internal vertical synchronizing signal IVS and the pixel clock signal PCK, to control the apparatus 200f. The control signal includes a source control signal 210d controlling the line memory part 230, the frame memory part 240, the image compensation part 250 and the source driving part 260 processing the image signal, and a gate control signal 210g controlling the gate control part 270.

The voltage generating part 220 generates the driving voltages based on the control of the timing control part 210. The driving voltages includes gate voltages VL and VH applied to the gate control part 270, a reference gamma voltage VREF applied to the source driving part 260, and a common voltage VCOM applied to the display panel 100.

The line memory part 230 stores the image signal of the n-th frame Fn, which is synchronized with the internal horizontal synchronizing signal IHS, the internal vertical synchronizing signal IVS and the pixel clock signal PCK and is received from the external system, in the line unit. The line memory part 230 outputs the image signal of the n-th frame Fn to the image compensation part 250 in the pixel unit and the frame memory part 240.

The frame memory part 240 outputs the stored image signal of the (n-1)-th frame Fn-1 to the image compensation part 250 in the pixel unit, based on the source control signal 210d synchronized with the pixel clock signal PCK, and stores the image signal of the n-th frame Fn, which is outputted from the line memory part 230.

For example, after the k-th line image signal of the n-th frame Fn is stored in the line memory part 230, the line memory part 230 outputs the k-th line pixel image signal 230P of the n-th frame to the image compensation part 250. The frame memory part 240 outputs the k-th line pixel image signal 240P of the (n-1)-th frame Fn-1 to the image compensation part 250.

The n-th frame Fn pixel image signal 230P and the pixel image signal 240P of the (n-1)-th frame Fn-1 are inputted to the image compensation part 250. The image compensation part 250 includes an LUT in which the compensated image signal or the operating parameter is mapped corresponding to the image signal of the (n-1)-th frame and the image signal of the n-th frame. The image compensation part 250 outputs the pixel compensated image signal Fn′ of the n-th frame to the source driving part 260 corresponding to the pixel image signal 230P of the n-th frame and the pixel image signal 240P of the (n-1)-th frame using the LUT.

The source driving part 260 groups the compensated image signal Fn′ in the pixel unit into the compensated image signal in the line unit, and converts the compensated image signal in the line unit into an analog-type compensated image signal D1, D2, . . . , Dk, to output the compensated image signal in the line unit to the source lines of the display panel 100.

The gate control part 270 shifts the level of the gate control signal 210g provided from the timing control part 210 and the gate voltage VL and VH provided from the voltage generating part 220, to apply the gate control signal 210g and the gate voltage VL and VH to the gate driving part 110. For example, a vertical start signal STV, a first clock signal CK, a second clock signal CKB, a gate on voltage VDD and a gate off voltage VSS are inputted to the gate driving part 110.

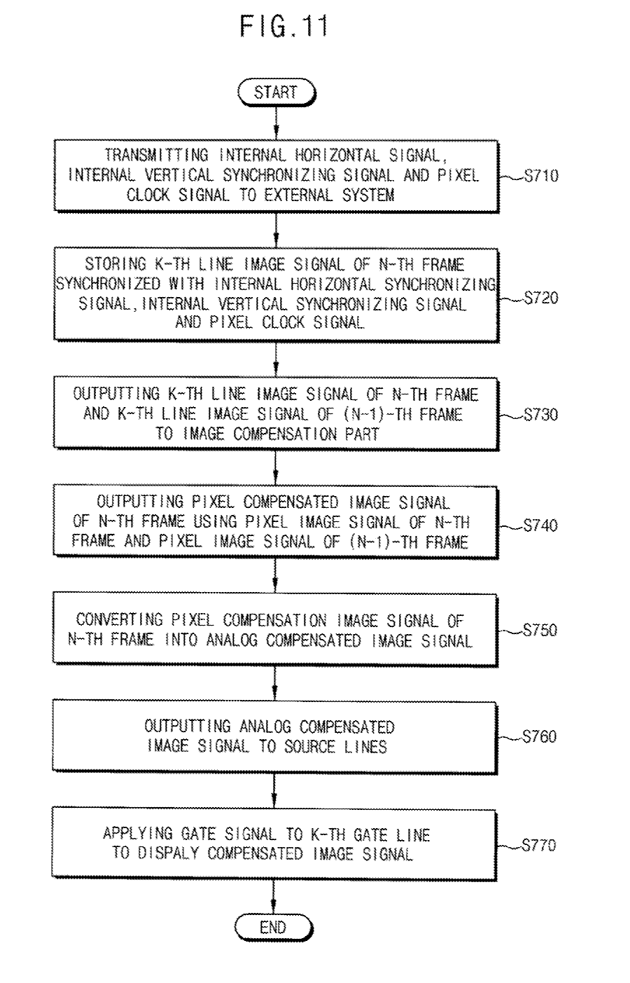

FIG. 11 is a flow chart showing a method according to an embodiment of the invention for driving the apparatus 200f in FIG. 10.

Referring to FIGS. 1, 10 and 11, the apparatus 200f transmits an internal horizontal synchronizing signal IHS, an internal vertical synchronizing signal IVS and an pixel clock signal PCK to the external system (step S710).

In the apparatus 200f, a line memory part 230 stores a k-th line image signal of an n-th frame Fn that is synchronized with the internal horizontal synchronizing signal IHS, the internal vertical synchronizing signal IVS and the pixel clock signal PCK and is received from an external system via the CPU interface process (step S720).

When the k-th line image signal of n-th frame Fn is applied to the line memory part 230, the k-th line image signal of the n-th frame Fn, which is synchronized with the pixel clock signal PCK, is outputted in the pixel unit. For example, the line memory part 230 outputs a pixel image signal 230P of the n-th frame Fn to an image compensation part 250 (step S730).

A frame memory part 240 outputs the stored k-th line image signal of the (n-1)-th frame Fn-1, which is synchronized with the pixel clock signal PCK in the pixel unit. For example, the frame memory part 240 outputs the pixel image signal 240P of the (n-1)-th frame Fn-1 to the image compensation part 250 (step S730).

The image compensation part 250 outputs a pixel compensated image signal Fn′ of the n-th frame using the pixel image signal 230P of the n-th frame Fn and the pixel image signal 240P of the (n-1)-the frame Fn-1 (step S740).

A source driving part 260 groups the pixel compensated image signal Fn′ of the n-th frame into the line unit, and converts the compensated image signal Fn′ of the n-th frame in the line unit into an analog-type compensated image signal D1, D2, . . . , Dk using a reference gamma voltage VREF (step S750).

The source driving part 260 outputs the analog-type k-th line compensated image signal D1, D2, . . . , Dk of the n-th frame to source lines (step S760).

The gate driving part 110 outputs a gate signal to gate lines of a display panel 100 based on a control of timing control part 210. When the k-th line compensated image signal Fn′ is outputted to the source lines, the gate signal is applied to the gate line GLk corresponding to the k-th line. Thus, a compensated image is displayed on the display panel 100 based on the compensated image signal (step S770).

According to embodiments of the present invention, a compact display apparatus using a CPU interface process includes a line memory part storing an image signal in a line unit, so that an image signal of an (n-1)-th frame is synchronized with an image signal of an n-th frame to generate a compensated image signal of the n-th frame. Thus, video display quality may be enhanced in the compact display apparatus using the CPU interface process.

Having described example embodiments of the present invention and their features, it is noted that various changes, substitutions and alterations can be made herein without departing from the spirit and scope of the invention as defined by appended claims.

What is claimed is:

1. An apparatus for driving a display panel, the apparatus comprising:
a timing control part receiving an external horizontal synchronizing signal from an external system via a central processing unit (CPU) interface process;
a line memory part storing an image signal of an n-th frame in a line unit, based on the external horizontal synchronizing signal, the image signal of the n-th frame being transmitted from the external system;
a frame memory part storing an image signal of the (n-1)-th frame based on the external horizontal synchronizing signal; and
an image compensation part generating an n-th frame compensated image signal using the image signals of the n-th and (n-1)-th frames that are respectively outputted from the line memory part and the frame memory part based on the external horizontal synchronizing signal,
wherein n is a natural number.

2. The apparatus of claim 1, further comprising a source driving part converting the compensated image signal of the n-th frame into an analog-type compensated image signal, and outputting the analog-type compensated image signal.

3. The apparatus of claim 1, further comprising:
a resistor recording a start point of a frame using the external horizontal synchronizing signal; and
a clock generating part generating an internal vertical synchronizing signal using the start point of the frame recorded in the resistor.

4. The apparatus of claim 3, wherein the timing control part controls the line memory part, the frame memory part and the image compensation part using the internal vertical synchronizing signal.

5. The apparatus of claim 3, wherein the clock generating part divides the external horizontal synchronizing signal to generate a pixel clock signal.

6. The apparatus of claim 5, wherein the line memory part synchronizes the image signal of the n-th frame with the pixel clock signal to output the image signal of the n-th frame in a pixel unit.

7. The apparatus of claim 6, wherein the frame memory part synchronizes the image signal of the (n-1)-th frame with the pixel clock signal to output the image signal of the (n-1)-th frame in the pixel unit.

8. The apparatus of claim 7, wherein the image compensation part generates the compensated image signal of the n-th frame in the pixel unit, using the image signals of the n-th and (n-1)-th frames in the pixel unit.

9. The apparatus of claim 1, wherein the timing control part receives an external vertical synchronizing signal from the external system.

10. The apparatus of claim 9, wherein the timing control part controls the line memory part, the frame memory part and the image compensation part based on the external vertical synchronizing signal.

11. An apparatus for driving a display panel, the apparatus comprising:
a clock generating part generating an internal horizontal synchronizing signal and an internal vertical synchronizing signal;
a timing control part transmitting the internal horizontal synchronizing signal and the internal vertical synchronizing signal to an external system via a central processing unit (CPU) interface process;
a line memory part storing an image signal of an n-th frame in a line unit, the image signal of the n-th frame being synchronized with the internal horizontal synchronizing signal and being received from the external system;
a frame memory part storing an image signal of an (n-1)-th frame based on the internal horizontal synchronizing signal; and
an image compensation part generating a compensated image signal of the n-th frame using the image signals of the n-th and (n-1)-th frames based on the internal horizontal synchronizing signal, the image signals of the n-th and (n-1)-th frames being respectively outputted from the line memory part and the frame memory part,
wherein n is a natural number.

12. The apparatus of claim 11, further comprising a source driving part converting the compensated image signal of the n-th frame into an analog-type compensated image signal, and outputting the analog-type compensated image signal.

13. The apparatus of claim 11, wherein the clock generating part further generates a pixel clock signal, and the timing control part transmits the pixel clock signal to the external system.

14. The apparatus of claim 13, wherein the external system transmits an image signal synchronized with the pixel clock signal.

15. The apparatus of claim 13, wherein the timing control part controls the line memory part, the frame memory part and the image compensation part using the pixel clock signal.

16. The apparatus of claim 13, wherein the line memory part synchronizes the image signal of the n-th frame with the pixel clock signal to output the image signal of the n-th frame in a pixel unit.

17. The apparatus of claim 16, wherein the frame memory part synchronizes the image signal of the (n-1)-th frame with the pixel clock signal to output the image signal of the (n-1)-th frame in the pixel unit.

18. The apparatus of claim 17, wherein the image compensation part generates the compensated image signal of the n-th frame in the pixel unit, using the image signals of the n-th and (n-1)-th frames in the pixel unit.

19. A method for driving a display panel, the method comprising:
receiving an external horizontal synchronizing signal and an image signal of an n-th frame, the external horizontal synchronizing signal and the image signal of the n-th frame being transmitted from an external system via a CPU interface process;
storing the image signal of the n-th frame in a line unit, based on the external horizontal synchronizing signal;
outputting the stored image signals of the (n-1)-th and n-th frames based on the external horizontal synchronizing signal;
generating an n-th frame compensated image signal using the image signals of the n-th and (n-1)-th frames;
converting the compensated image signal of the n-th frame into an analog-type compensated image signal; and
outputting the analog-type compensated image signal,
wherein n is a natural number.

20. The method of claim 19, further comprising dividing the external horizontal synchronizing signal to generate a pixel clock signal.

21. The method of claim 20, wherein the image signals of the (n-1)-th and n-th frames are outputted by outputting the stored image signals of the (n-1)-th and n-th frames in a pixel unit based on the pixel clock signal.

22. The method of claim 21, wherein the compensated image signal of the n-th frame is generated by generating the compensated image signal of the n-th frame in the pixel unit using the image signals of the n-th and (n-1)-th frames in the pixel unit.

23. A method for driving a display panel, the method comprising:
generating an internal horizontal synchronizing signal and an internal vertical synchronizing signal;
transmitting the internal horizontal synchronizing signal and the internal vertical synchronizing signal to an external system via a CPU interface process;
storing an image signal of an n-th frame in a line unit, the image signal of the n-th frame being synchronized with the internal horizontal synchronizing signal and being received from the external system;
outputting the stored image signals of the (n-1)-th and n-th frames based on the internal horizontal synchronizing signal;
generating a compensated image signal of the n-th frame using the image signals of the n-th and (n-1)-th frames;
converting the compensated image signal of the n-th frame into an analog-type compensated image signal; and
outputting the analog-type compensated image signal,
wherein n is a natural number.

24. The method of claim 23, further comprising:
generating a pixel clock signal;
transmitting the pixel clock signal to the external system; and
receiving an image signal synchronized with the pixel clock signal from the external system.

25. The method of claim 24, wherein the image signals of the (n-1)-th and n-th frames are outputted by outputting the stored image signals of the (n-1)-th and n-th frames in a pixel unit based on the pixel clock signal.

26. The method of claim 25, wherein the compensated image signal of the n-th frame is generated by generating the compensated image signal of the n-th frame in the pixel unit using the image signals of the n-th and (n-1)-th frames in the pixel unit.
